(19) United States
(12) Patent Application Publication
(10) Pub. No.: US 2010/0181336 A1
(43) Pub. Date: Jul. 22, 2010

(54) ASSEMBLY FOR DISPENSING A BEVERAGE

(75) Inventor: Jan N. Rasmussen, Olstykke (DK)

Correspondence Address: KLEIN, O''NEILL & SINGH, LLP, 18200 VON KARMAN AVENUE, SUITE 725, IRVINE, CA, 92612, US

(73) Assignee: CARLSBERG BREWERIES A/S, Copenhagen V (DK)

(21) Appl. No.: 12/063,540

(22) PCT Filed: Aug. 10, 2006
(86) PCT No.: PCT/DK2006/000437

§ 371 Date: Mar. 29, 2010

(30) Foreign Application Priority Data
Aug. 12, 2005 (DK) 200501145
Mar. 14, 2006 (DK) 200600362

(51) Int. Cl. B67D 3/00; B67D 1/12; B67D 7/06

(52) U.S. Cl. 222/1; 222/505; 222/564

(57) ABSTRACT

A beverage-dispensing assembly (1) includes a dispensing line (7), a dispensing tap (10), and a dispensing valve (12) arranged at a downstream end of the dispensing line (7), wherein the dispensing valve (12) is interchangeable and arranged in connection with any of a plurality of embodiments of interaction means (14). Each of the embodiments of the interaction means (14) is configured for dispensing a specific kind of beverage, so as to achieve a beverage-specific dispensing for each embodiment of the interaction means (14).

### TECHNICAL FIELD OF THE INVENTION

The present invention relates to an assembly for dispensing a beverage, said assembly comprising a dispensing line, a dispensing tap and a dispensing valve arranged at a downstream end of the dispensing line. The invention also relates to interaction means for use in such an assembly as well as a method for beverage-specific dispensing by use of such an assembly and/or interaction means.

### BACKGROUND OF THE INVENTION

As the market for gourmet-type beverages, such as special kinds of ale, pilsner and stout beers, steadily increase, a growing demand for these products as draught-beers also increase. This is partly a consequence of the fact that ideal circumstances for such properties as pressure, temperature and foaming are more easily obtained in a draught system as compared to serving beverages from bottles or cans. Thus, to achieve the optimal taste, aroma and texture of e.g. a beer, it is often necessary to serve the beer from a draught system. As both the number of gourmet beverage products and the customer demand for these products increases, it becomes essential for restaurants, bars and pubs to offer a large variety of different beverages at the right quality. Thus, it is becoming increasingly more common for bars and pubs to offer a large number of different quality draught beverages in order to meet the demand of customers.

In addition, as gourmet beverage consumption increases, a growing number of people wish to have access to quality draught beverages in their own homes. At the same time, though, many people wish to have the possibility of serving a number of different types of draught beverages, such as ciders, pilsners, ales and stouts, in their homes.

There is thus a need for providing professionals as well as private people with a large selection of quality beverages. There is also a need for providing these quality beverages in a form, which brings out the best in the beverage and thus ensures high customer satisfaction. There is furthermore a constant need for reducing the costs of such quality products as well as a need for increasing user-friendliness of systems for dispensing quality beverages such as draught beer.

Presently, the customer demand for a large selection of quality beverages is being met by a number of bars, pubs and restaurants by offering a wide range of bottled and canned beverages. It is also common for such places to have a small selection of beverages on draught, for instance 1-5 different kinds of beer or cider. In private homes, the most common way to achieve a good selection of quality beverages is by buying bottled or canned beverages and storing them in a cellar or refrigerator.

A number of disadvantages are associated with the above manners of achieving the desired selection of quality beverages. Bottled and canned beverages, such as beers and ciders, even high-quality ones, do not measure up to the taste, aroma and texture achieved in the draught versions of the same beverages. Thus, while achieving a wide selection with bottles and cans, the quality is somewhat compromised. A small selection of draught beverages will seldom meet the demands of all customers, while a large selection of draught beverages requires large investments in dispensing equipment. Also, even pressurized beverages in kegs have a limited shelf life, especially after having been opened. Thus, a wide selection of draught beverages may lead to undesirable waste due to very low turnover of some types of beverage.

Draught systems for private use are known in the art, however it is uncommon for private homes to have more than one such system. Since different types of beverages often require different ways of dispensing, it is often difficult or impossible to get access to a variety of draught beverages at home. Furthermore, suppliers of quality draught beverages may be reluctant to deliver such products to consumers without proper equipment to dispense the beverage in a suitable way. Equipment not suited or adapted for dispensing a specific beverage may considerably reduce the quality of the final dispensed product, thus leaving the consumer with an unsatisfactory impression of the beverage.

There is thus a need for providing a remedy for the above-mentioned disadvantages. More specifically, there is a need for providing professionals and private persons alike with access to a larger selection of quality beverages served in a manner suitable for such beverages both at home and in bars, restaurants and pubs.

It is an objective of the present invention to provide a remedy to the above-mentioned disadvantages of the known techniques. It is more specifically an objective of the present invention to provide a flexible assembly for dispensing a beverage, which makes it possible, easy and inexpensive to offer a large selection of quality draught beverages at home or in bars, restaurants and pubs.

### SUMMARY OF THE INVENTION

The present invention is new and inventive in that it provides an assembly for dispensing a beverage, said assembly comprising a dispensing line, a dispensing tap and a dispensing valve arranged at a downstream end of the dispensing line, characterized in that the dispensing valve is interchangeable and arranged in connection with interaction means, said interaction means being adapted for affecting a specific kind of beverage being dispensed, as to achieve a beverage-specific dispensing. The matter is, that beverage may be dispensed from a container, through the dispensing line to a dispensing tap where the beverage is dispensed through a dispensing valve. By arranging interaction means at the dispensing valve, the physical properties of a flowing beverage may be affected by the interaction means before dispensing into e.g. a glass. Thus, desirable beverage-specific properties of the dispensed beverage may be obtained by the interaction with the interaction means. Interaction means according to the invention may be used with all kinds of dispensing assemblies (i.e. also existing assemblies) and may be adapted for incorporation in a particular assembly or for fitting into a number of different assemblies.

The interaction means may comprise adaptor parts, such as quick-lock or quick-release parts, for mounting the interaction means, e.g. at the dispensing line or at the valve. Adaptor parts arranged e.g. for complementary interaction with parts of the dispensing line, dispensing tap or dispensing valve, provides an easy method of freely interchanging the interaction means according to need. Such adaptor parts may for instance be made by injection moulding.

The interaction means may be mounted upstream of the valve, such as at the dispensing line. Mounting upstream of the valve ensures that pressure build up upstream of the interaction means does not cause a leak through the valve. The matter is, that even good quality valves may have sensitive parts not adapted for the high pressure which may build up upstream of the interaction means.

The valve may comprise the interaction means, e.g. as an integrated part of the valve. To incorporate the interaction means into the dispensing valve is especially preferable for achieving easy one-step exchange of both valve and interaction means. It may also lower total production cost by allowing the valve and the interaction means to be produced together, for instance by injection moulding. The interaction means should preferably be incorporated upstream of the opening mechanism of the valve in order to avoid leakage as described previously. No such problems of leakage should result from integrating the interaction means correctly, that is preferably upstream of the opening mechanism of the valve, into the valve.

The interaction means may be adapted for facilitating a pressure drop in the beverage being dispensed. Such a, possible large and/or sudden, pressure drop across the interaction means may be suitable for achieving the desired beverage specific properties of a beverage. For instance, a pressure drop may lead to gas-breakout and foam formation in e.g. draught beer.

The interaction means may be adapted for affecting a flow of beverage being dispensed, such as by achieving a change from laminar beverage flow to turbulent beverage flow or vice versa. Such changes in flow properties may be an advantageous way of achieving desirable beverage-specific properties of the beverage to be dispensed.

The interaction means may comprise a plate with at least one aperture through which beverage may flow. Such an aperture plate may be a convenient way of achieving both pressure drops and altered flow properties in a beverage passing an interaction means. Small apertures, optionally with sharp edges, are especially suitable for facilitating pressure drops and turbulence. The interaction means may comprise a large number, such as more than 20, of apertures, which may be preferable for achieving the desired effects.

The interaction means may be made of metal, plastic, rubber or a combination thereof. Interaction means made of plastic may be especially preferable for lowering production costs, for instance by injection moulding the interaction means. The interaction means may optionally be coated or treated in some other manner in order to ensure good hygienic properties.

In another preferred embodiment the interaction means is an integral part of the interchangeable valve. By the expression “the interaction means is an integral part of the interchangeable valve” is meant that the interaction means is constructed as a part of the valve and is inseparable from said valve. The matter is that the interaction means by being an integral part of the valve can easily be manufactured, supplied and removed along with the valve.

The present invention is also new and inventive in that it provides interaction means for us in an assembly for dispensing a beverage, wherein said interaction means are adapted for affecting a specific kind of beverage being dispensed, as to achieve a beverage-specific dispensing

The interaction means may be adapted for facilitating gas-breakout in a CO₂- and/or N₂-containing beverage, such as by facilitating a sudden pressure drop. The matter is, that pressure drops may cause gas-breakout in a gas-containing beverage. Gas-breakout occurs when the pressure affecting the beverage drops below the pressure required to keep the gas in the solution. This pressure varies with the temperature of the beverage and may also vary for different beverages containing different gasses or mixtures of gasses. Gas-breakout may cause a desired foam formation in a beverage being dispensed, such as is the case with N₂ gas breakout and consequent foam formation in so-called stout beers. The interaction means may be adapted for affecting the properties of a beverage being dispensed in other ways, such as by affecting the flow of beverage.

The interaction means may comprise an aperture plate with at least one aperture through which a beverage may flow, such through-flow facilitating a pressure drop across the aperture plate and optionally increased turbulence downstream of the aperture plate. The mentioned pressure drop and optional turbulence may also be achieved by other means than an aperture plate.

The interaction means may be an integral part of an interchangeable valve.

The present invention is furthermore new and inventive by disclosing a method for beverage-specific dispensing by use of an assembly for dispensing a beverage and/or interaction means, said method comprising the steps of dispensing beverage from a container through a dispensing line, a dispensing tap and a dispensing valve; and allowing the beverage to flow through an interaction means located upstream of the dispensing valve and adapted for affecting a specific kind of beverage being dispensed, as to achieve a beverage-specific dispensing.

### BRIEF DESCRIPTION OF THE DRAWINGS

The invention and its many advantages will be described in more detail below with reference to the accompanying schematic drawings, which for the purpose of illustration show some non-limiting embodiments and in which

FIG. 1 shows an embodiment of an assembly for dispensing a beverage,

FIG. 2 shows another embodiment of an assembly for dispensing beverage,

FIG. 3 shows an embodiment of a dispensing tap,

FIG. 4 shows an embodiment of a dispensing valve connected to a dispensing line in perspective,

FIG. 5 shows an embodiment of a dispensing valve connected to a dispensing line in cross-section,

FIG. 6 shows an embodiment of an interaction means,

FIG. 7 shows an embodiment of a dispensing tap, and

FIG. 8 shows a sectional view of an embodiment of a dispensing valve wherein the interaction means is an integral part.

All the figures are highly schematic and not necessarily to scale, and they show only parts which are necessary in order to elucidate the invention, other parts being omitted or merely suggested.

### DETAILED DESCRIPTION OF PREFERRED EMBODIMENTS

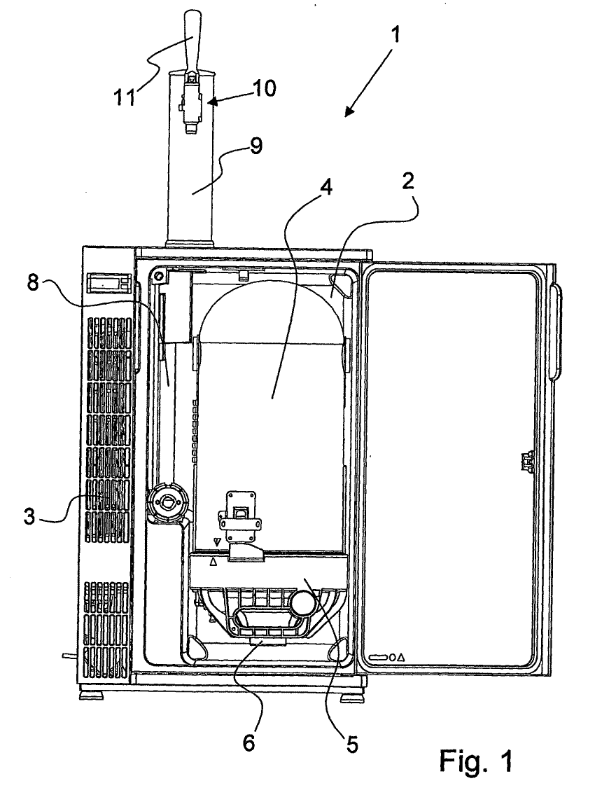

FIG. 1 shows an embodiment of an assembly 1 for dispensing a beverage comprising a cooling chamber 2, a cooling system 3, a container (not visible) within a pressure chamber 4, a pressure chamber lid 5 with an opening 6 for a dispensing line 7 (not shown), a dispensing line channel 8, a tower 9, a dispensing tap 10 and a tap actuator 11. It should be noted that the assembly shown in FIG. 1 is only an example of an assembly in which interaction means 14 according to the invention may be used. Interaction means 14 may be employed within any other type of assembly 1, and may optionally be adapted for easy incorporation into a specific assembly 1 or a number of different assemblies 1.

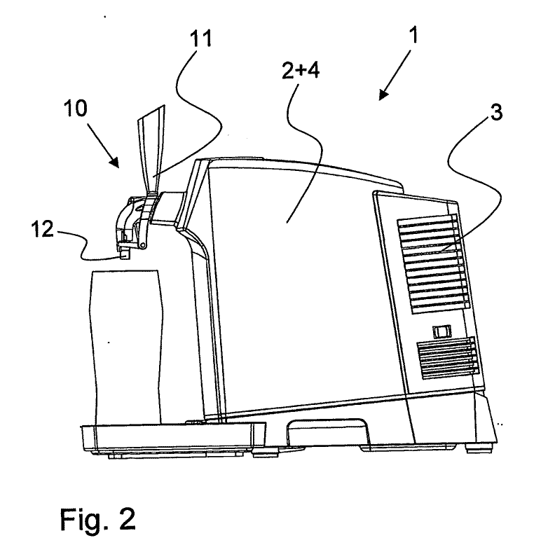

FIG. 2 shows another embodiment of an assembly 1 for dispensing beverage comprising a combined cooling and pressure chamber 2+4, a cooling system 3, a dispensing tap 10, a tap actuator 11 and a dispensing valve 12. In this particular embodiment the cooling chamber 2 and the pressure chamber 4 are combined into one single chamber 2+4, which may serve both purposes.

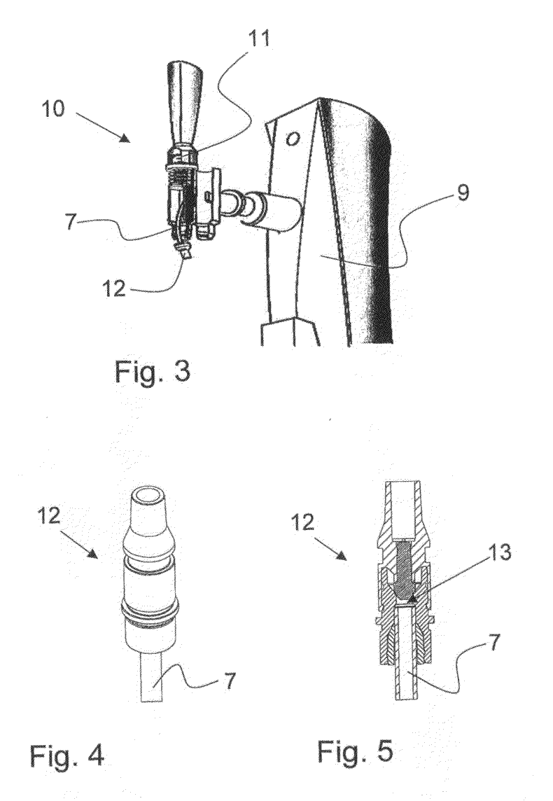

FIG. 3 shows an embodiment of a dispensing tap 10. The dispensing tap 10 comprises a tap actuator 11 and is mounted on a tower 9. Protruding from the dispensing tap 10 is a dispensing line 7 in connection with a dispensing valve 12. The dispensing tap 10 is shown in an open configuration, but may be closed around the dispensing line 7 and dispensing valve 12 to ready the dispensing tap 10 for use. Such easy opening and closing of the dispensing tap 10 makes it easy to interchange or replace parts within the dispensing tap 12, such as e.g. a dispensing valve 12 or interaction means 14. The valve 12 is an interchangeable valve 12, which may be changed independently of the other components of the assembly 1. The valve comprises interaction means 14 (not shown in this fig.).

FIG. 4 shows a perspective view of an embodiment of a dispensing valve 12. The valve 12 is seen in connection with a dispensing line 7.

FIG. 5 shows a cross-sectional view of an embodiment of a valve 12 in connection with a dispensing line 7. A possible position of an interaction means 14 (not shown in this fig.) is indicated with the arrow 13. The interaction means 14 may comprise adaptor parts for easy and flexible connection to other parts of the assembly, and may, during use of the assembly be connected to the dispensing line 7, the dispensing valve 12 or the dispensing tap 10. Making the interaction means 14 adaptable for connection with different other parts of the assembly may enhance the overall flexibility and user-friendliness of the assembly. For instance, the interaction means 14 may be inserted between the dispensing line 7 and the dispensing valve 12. The interaction means 14 may also be positioned in the downstream end of the dispensing line 7 or as a part of the dispensing tap 10. Thus, the interaction means 14 may optionally be an integral part of another part of the assembly 1, such as the dispensing line 7 or the valve 10, and may as such be part of a single-use disposable part. Such single-use parts may increase both user-friendliness and hygiene of an assembly considerably.

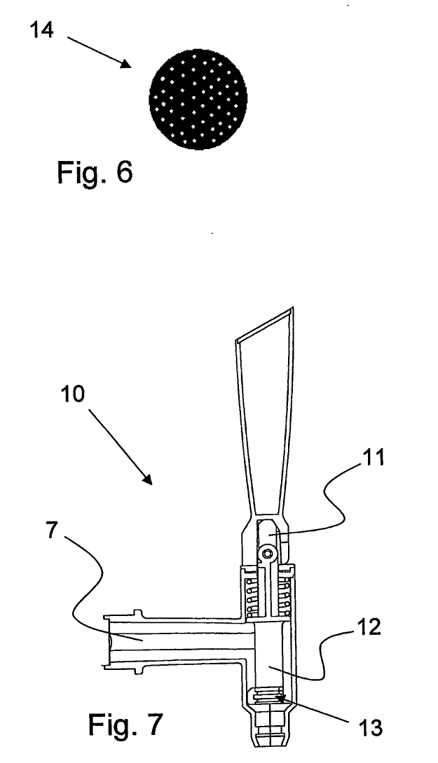

FIG. 6 shows an embodiment of an interaction means 14. In this particular embodiment, the interaction means is in the form of a plate with a number of apertures or holes. During use, when the interaction means 14 is mounted in an assembly 1, beverage may flow through the apertures. When beverage is forced through apertures such as the ones in the shown embodiment of the interaction means, a pressure drop occurs across the interaction means. Furthermore, the beverage flow after the apertures is likely to become turbulent, thus further reducing the pressure of the beverage. Such a pressure loss is well suited for promoting release of gas, that is bubble formation, in a gas-containing solution. Bubble formation is a prerequisite for the formation of foam in foaming beverages, such as beers and ciders. Since the foam of and on a beverage may contribute significantly to the taste as well as the visual and textual appeal, it is important to ensure correct foaming of a beverage being dispensed. This may be achieved by an interaction means 14 such as the one shown in FIG. 6. Different embodiments of interaction means 14 are suitable for different requirements to the physical properties of the beverage. For instance, the size and number of apertures may influence the manner in which a beverage is affected by the interaction means 14. Thus, different embodiments of interaction means 14 should be used for different beverages in order to obtain a beverage-specific dispensing which brings forth all qualities of the beverage.

FIG. 7 shows a cross-section of an embodiment of a dispensing tap 10 comprising a tap actuator 11, a dispensing valve 12 whereto a dispensing line 7 is led. A possible position of an interaction means 14 (not shown in FIG. 7) is indicated by the arrow 13. The interaction means 14 may be positioned within the dispensing valve 12, which may be advantageous for easy exchange of the interaction means 14 along with the dispensing valve 12. However, the interaction means 14 may, as previously mentioned, be positioned differently.

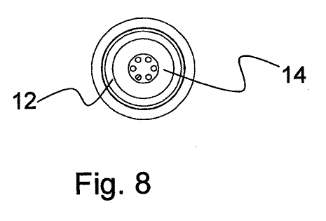

FIG. 8 shows a sectional view of an embodiment of an interchangeable dispensing valve 12 wherein the interaction means 14 is an integral part. The valve 12 is seen from one end and the interaction means 14 can be seen inside the valve 12. In this particular embodiment the interaction means 14 is constructed by making apertures in an integral part, e.g. a small plate, of the valve 12. Beverage flowing through the valve 12 thus also passes through these apertures. Having the interaction means 14 as an integral part of the valve 12 has the advantage that the interaction means 14 is automatically supplied and removed along with the interchangeable valve 12. Thus, there is no risk of dropping or loosing the interaction means 14 in the process of changing the valve 12, and an old, and possibly contaminated, interaction means 14 is never mistakenly reused as part of the assembly 1 when the valve 12 is changed. Furthermore, when supplying the interchangeable valve 12 along with, or possibly connected to, a beverage container, e.g. a beer keg, the right kind of interaction means 14 to fit the beverage can always be supplied, thus making changes between different beverages easy and safe for the user. Additionally, constructing the interaction means 14 as an integral part of the valve 12 eliminates the separate production of the interaction means 14 and thus makes production both easier and less expensive.

Even though the methods and assembly 1, as well as some of the figures, disclose a valve 12 connected to the outlet end of the dispensing line 7, and though said valve 12 may be replaced attached to the dispensing line 7, it is within the inventive idea that the valve 12 also may be a separate valve 12, which is not necessarily replaced at the same time as the dispensing line 7. Thus, the outlet end of the dispensing line 7 and the valve 12 may comprise complementary connection means, which easily may be separated. Furthermore, the outlet end of the dispensing line 7 (as well as the inlet end if not mounted in a container) may comprise a cap, hood or cover which easily may be removed before the dispensing line 7 is mounted in the valve 12 and the container, respectively. Hereby, it is obtained that the interior of the dispensing line 7 may be kept clean, and contamination of the parts, which come in contact with the beverage, is avoided. The valve 12 may also comprise a cap, hood or cover for the same reasons as mentioned above.

Although the invention above has been described in connection with preferred embodiments of the invention, it will be evident for a person skilled in the art that several modifications are conceivable without departing from the invention as defined by the following claims.

1-15. (canceled)

16. A beverage-dispensing assembly (1), of the type comprising a dispensing line (7), a dispensing tap (10), and a dispensing valve (12) arranged at a downstream end of the dispensing line (7), wherein the assembly (1) is characterized in that the dispensing valve (12) is interchangeable and arranged in connection with any of a plurality of embodiments of interaction means (14), each of the embodiments being configured for dispensing a specific kind of beverage, so as to achieve a beverage-specific dispensing for each embodiment of the interaction means (14).

17. The assembly (1) of claim 16, wherein the interaction means (14) comprises adaptor parts configured and arranged for mounting the interaction means (14) in the dispensing line (7).

18. The assembly (1) of claim 16, wherein the interaction means (14) comprise adaptor parts configured and arranged for mounting the interaction means (14) in the dispensing valve (12).

19. The assembly (1) of claim 16, wherein the interaction means (14) are mounted upstream of the dispensing valve (12).

20. The assembly (1) of claim 16, wherein the interaction means (14) are adapted for facilitating a pressure drop in the beverage being dispensed.

21. The assembly (1) of claim 16, wherein the interaction means (14) are configured for changing the flow of the beverage being dispensed between a laminar flow and a turbulent flow.

22. The assembly (1) of claim 16, wherein the interaction means (14) comprise a plate with at least one aperture through which the beverage may flow.

23. The assembly (1) of claim 16, wherein the interaction means (14) are made of a material selected from the group consisting of at least one of metal, plastic, and rubber.

24. The assembly (1) of claim 16, wherein the interaction means (14) are an integral part of the dispensing valve (12).

25. Interaction means (14) for use in a beverage-dispensing assembly (1) comprising a dispensing line (7), a dispensing tap (10), and an interchangeable dispensing valve (12) arranged at a downstream end of the dispensing line (7), wherein said interaction means (14) are arranged in connection with the dispensing valve (12) and configured to dispense a specific kind of beverage, so as to achieve a beverage-specific dispensing.

26. The interaction means (14) of claim 25, wherein the interaction means (14) are configured to be positioned in the dispensing line (7).

27. The interaction means (14) of claim 25, wherein the interaction means (14) are configured to be positioned in the dispensing valve (12).

28. The interaction means (14) of claim 25, wherein the interaction means (14) are configured to facilitate gas-breakout in a gas-containing beverage by facilitating a sudden pressure drop.

29. The interaction means (14) of claim 25, wherein the interaction means (14) comprise an aperture plate with at least one aperture through which a beverage may flow, thereby creating a pressure drop across the aperture plate and increased turbulence downstream of the aperture plate.

30. The interaction means (14) of claim 25, wherein the interaction means (14) are an integral part of the interchangeable dispensing valve (12).

31. A method for beverage-specific dispensing from a beverage-dispensing assembly (1) comprising a dispensing line (7) and a dispensing tap (10), the method comprising the steps of:
(a) providing an interchangeable dispensing valve (12) at a downstream end of the dispensing line (7);
(b) providing interaction means (14) operatively connected to the dispensing valve (12), wherein the interaction means (14) are any of a plurality of embodiments of interaction means, each embodiment being configured for dispensing a specific kind of beverage; and
(c) allowing the beverage to flow through the interaction means (14).
